(19) United States
(12) Patent Application Publication
(10) Pub. No.: US 2004/0191747 A1
(43) Pub. Date: Sep. 30, 2004

(54) Training assistant system

(75) Inventors: Hirokazu Atsumori, Hatoyama (JP); Tsuyoshi Yamamoto, Kawagoe (JP); Yukiko Hirabayashi, Kokubunji (JP); Naoki Tanaka, Tokyo (JP); Masashi Kiguchi, Kawagoe (JP); Hiroki Sato, Oi (JP); Hideo Kawaguchi, Hatoyama (JP); Takusige Katura, Hatoyama (JP); Yukari Yamamoto, Kunitachi (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/771,450

(22) Filed: Feb. 5, 2004

(30) Foreign Application Priority Data
Mar. 26, 2003 (JP) 2003-084339

(51) Int. Cl. G09B 7/00

(52) U.S. Cl. 434/323

(57) ABSTRACT

The training of a trainee is performed in response to an instruction from a training task presentation (110) and the trainee responds by using a trainee's response collection unit (111). At the same time, a brain activity measurement unit (101) and a signal converter (103) using a cable (102) for transmitting signals of brain activity measure the brain activity of the trainee. Through a comparison between a response from the trainee and the result of brain activity measurement, a training effect is evaluated and a next training task to be performed is determined. For optimum training, the training is evaluated based on both of a training effect which can be evaluated from the outer appearance and brain activity corresponding thereto.

### FIELD OF THE INVENTION

The present invention relates to a system for assisting a patient who needs rehabilitation or a person who wishes to perform image training with such rehabilitation or training.

### BACKGROUND OF THE INVENTION

A description will be given to a relationship between rehabilitation and image training to which the present invention is applied and brain activity. If a person receives a damage due to illness or an accident, he or she may have an impairment such as a degraded motor function or a lowered linguistic ability. There has been a report that a patient having such an impairment has a region in charge of the motor function, the linguistic ability, or the like damaged in the brain or the function of such a region is impaired. Accordingly, the relationship between rehabilitation and brain activity has drawn growing attention in recent years.

In the case of a patient having a functional disorder in the brain caused by the structural destruction of the brain or a patient having a functional disorder in the brain caused by a factor other than the structural destruction of the brain, such as a cerebrovascular disorder, it is difficult for the damaged region to recover its inherent function but it has been known that the function is restored as a result of compensation by a region surrounding the damaged region or other than the damaged region. Non-Patent Document 1 introduces a large number of cases of functional compensation in the brain revealed by a brain activity measurement method such as PET (Positron Emission Tomography).

On the other hand, Non-Patent Document 2 reports that, as a result of measuring brain activity in either of the cases where a person was actually performing a physical movement and where the person just imagined the physical movement without performing it, a region in charge of the physical movement was active in both of the cases. This indicates that brain activity similar to that when the person performed the physical movement occurred even though the person did not actually move his or her body. In a region termed a working memory having the function of temporarily retaining memory in the frontal cortex, activity is vigorous at the initial stage of physical movement training but the level of activity gradually lowers as the person being trained is more skilled at the movement. The reason for this may be that the person who has just begun the unfamiliar training needs intervention of the temporary memory region at the initial stage thereof to get accustomed to the movement but, as the person is more skilled, he or she can move quickly without intervention of the temporary memory retention region.

Examples of a conventional rehabilitation system for a patient having a functional disorder in the brain include a training tool (Patent Document 1) for a patient with unilateral spatial agnosia or a system (Patent Document 2) featuring the presentation of a virtual environment to a patient. However, none of them has focused attention on the relationship between a training effect and brain activity. As for other methodologies and their compensatory systems associated with rehabilitation, image training, and the like, none of them has focused attention on the relationship between brain activity and the result of measuring brain function and a training effect.

It takes a long time until such training as rehabilitation or image training eventually achieves a visible effect. In accordance with the conventional technologies, however, the process until the effect becomes visible is obscure. A patient under rehabilitation or an athlete undergoing image training or the like is expected to just continue the training until it achieves a visible effect. There has been no existing means or system that focuses attention on the relationship between such training and brain activity and feedbacks the stages until a training effect is visibly recognized to the patient or athlete being trained in preparation for a next-stage training menu.

[Patent Document 1] Japanese Unexamined Patent Publication No. HEI 5-300908

[Patent Document 2] Japanese Unexamined Patent Publication No. 2001-79050

[Non-Patent Document 1] Yukihiro Fujii et al., “Functional Recovery and Neuronal Reorganization”, Shinkei Kenkyu no Shinpo (Advances in Neurological Sciences), Vol. 43, No. 4, pp. 552-560, 1999, IGAKU-SHOIN Ltd., Tokyo, Japan.

[Non-Patent Document 2] Hideaki Koizumi, “BRAIN 21 Developing-Learning-Healing” pp. 308-318, 2001, Kousakusha, Tokyo, Japan.

[Non-Patent Document 3] Vlad Toronov et al., “Phase Synchronize Index”, Medial Physics, Vol. 24, No. 4, pp. 801-815, 2000.

### SUMMARY OF THE INVENTION

It is therefore an object of the present invention to provide a training assistant system which presents, to a trainee, training effects at different stages of training such as rehabilitation or image training, allows the training effects to be reflected particularly in a next training task to be performed, and indicates and provides the next training task to the trainee or the like.

A training assistant system comprises: a training task presentation unit for presenting a training task and a training content to a trainee; a trainee's response collection unit for collecting, from the trainee, a response in accordance with the training task and the training content; a brain activity measurement unit for measuring brain activity of the trainee; and an information processor for controlling the training task presentation unit and determining a next training task to be performed by using the response from the trainee and a result of measuring the brain activity in a training process, which is obtained from said brain activity measurement unit, such that an effect of training which can be evaluated from a change in brain activity in the training process is reflected in the determination of the next training task to be performed. If necessary, the changing of evaluation criteria for the response from the trainee is permitted to give a training incentive to the trainee.

### BRIEF DESCRIPTION OF THE DRAWINGS

FIG. 1 is a block diagram showing a schematic structure of a training assistant system according to the present invention;

FIG. 2 is a view showing an example of presentation of the result of brain activity measurement in accordance with brain activity;

FIG. 3 is a view showing another example of presentation of the result of brain activity measurement in accordance with brain activity;

FIG. 4 is a flow chart illustrating a training procedure according to a first embodiment of the present invention;

FIG. 5 is a view showing an example of a screen presenting a calculation training task in the training procedure according to the first embodiment;

FIG. 6 is a view showing an example of a screen presenting a memorization training task in the training procedure according to the first embodiment;

FIGS. 7A to 7C are views illustrating examples of a screen displayed for the selection of an answer to the presented memorization training task of FIG. 6;

FIG. 8 is a flow chart illustrating a search procedure for searching a region of interest with a damage in the brain according to a second embodiment of the present invention;

FIGS. 9A and 9B are views showing examples of a screen presenting an image training task according to the second embodiment;

FIG. 10 is a flow chart illustrating a training procedure according to a third embodiment of the present invention;

FIG. 11 is a flow chart illustrating a training procedure according to a fourth embodiment of the present invention; and

FIG. 12 is a view showing an example of a screen presenting an image training task according to a sixth embodiment of the present invention.

### DESCRIPTION OF THE PREFERRED EMBODIMENT

For the sake of avoiding confusion, terminology used in the present invention will be defined as follows. A trainee is a person who wears a brain activity measurement unit and performs a task in training such as rehabilitation or image training. A trainer is a person who gives an instruction to the trainee, if necessary, and assists the trainee with training. The trainer is, e.g., a training specialist, a doctor, a family member of the trainee, or an acquaintance thereof.

### EMBODIMENT OF TRAINING ASSISTANT SYSTEMS

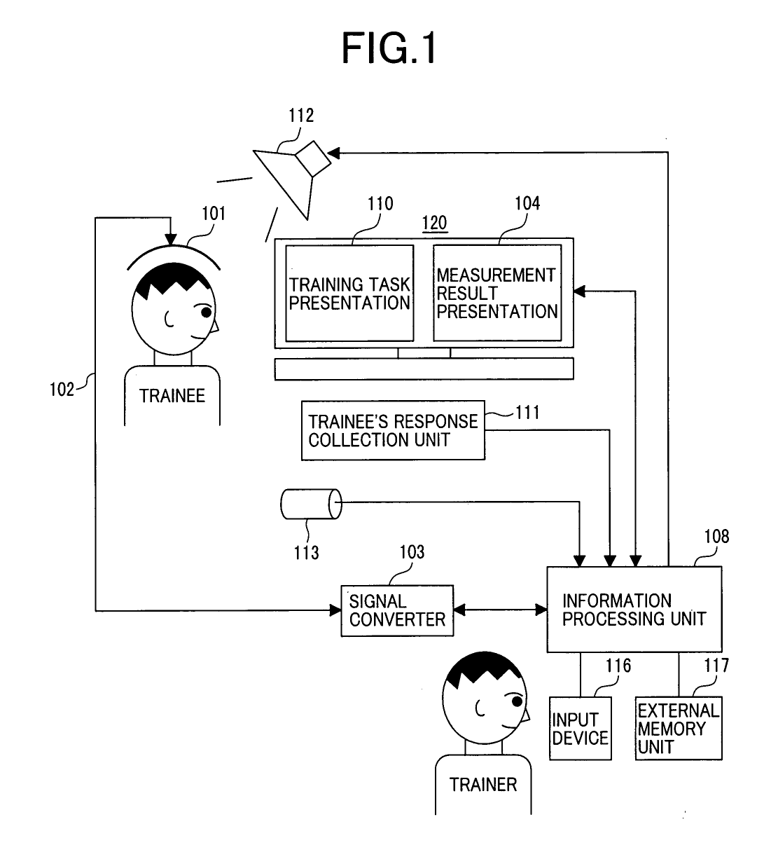

FIG. 1 is a block diagram showing a schematic structure of a training assistant system according to the present invention, in which 101 denotes a brain activity measurement unit, 102 is a cable for transmitting signals of brain activity, 103 denotes a signal converter, and 108 denotes an information processor, i.e., a so-called personal computer. The information processor 108 is internally equipped with: a memory for storing training programs which can be selected in accordance with the impairment of the trainee, information on responses from the trainee, measurement signals corresponding to the brain activity of the trainee which has been measured via the brain activity measurement unit 101 worn by the trainee, and the like; and a CPU, while it is externally equipped with: an input unit 116 such as a keyboard or a mouse through which the trainer performs the operation of selecting among the training programs; a trainee's response collection unit 111 for collecting a response from the trainee to stimuli given by the training program; a display unit 120 having a training task presentation 110 and a measurement result presentation 104; a speaker 112 for giving auditory stimuli to the trainee; and a microphone 113 for the trainee to respond to the auditory stimuli. If required, an external memory unit 117 such as a hard disk may also be provided.

The brain activity measurement unit 101 has: a light emitting probe for emitting near infrared light from over the scalp of the trainee; and a light detecting probe for detecting the emitted near infrared light that has reached the cerebral cortex through complicated scattering and absorption in living tissues in the head of the trainee, has been absorbed by blood in the cerebral cortex, and has returned to the scalp. The cable 102 for transmitting signals of brain activity has a plurality of optical fibers which transmit, to the emitting probe, near infrared light obtained by converting a light emission signal given by the information processor 108 to a light intensity signal by using the signal converter 103 and transmit, to the signal converter 103, the emitted near infrared light that has returned to the scalp and detected by the light detecting probe. The signal converter 103 converts the detected near infrared light to the corresponding electric signal and passes it to the information processor 108. If a given region in the cerebral cortex is activated, an amount of blood in the region changes so that an amount of the near infrared light emitted from the light emitting probe and absorbed by the blood changes. In response to the change, the intensity of the near infrared light detected on the scalp of the trainee by the light detecting probe changes so that the active region in the brain and the level of activation are determined. Thus, the measurement of the brain function of the trainee is performed by the emission and detection of the near infrared light.

The trainer operates the input unit 116 to select among the training programs in the information processor 108 in accordance with the impairment of the trainee. In response to the operation, the information processor 108 displays the training task presentation 110 on the display unit 120 or outputs a sound for giving auditory stimuli via the speaker 112. The trainee responds to the display of the training task presentation 110 or to the auditory stimuli given by the speaker 112. The response is transmitted to the information processor 108 by an action of the trainee such as, e.g., the operation of the trainee's response collection unit 111, a touch on the screen of the training task presentation 110 being displayed, or a speech in a voice to the microphone 113. At the same time, the signal corresponding to the brain activity is transmitted to the information processor 108 via the near infrared light detected by the light detecting probe of the brain activity measurement unit 101.

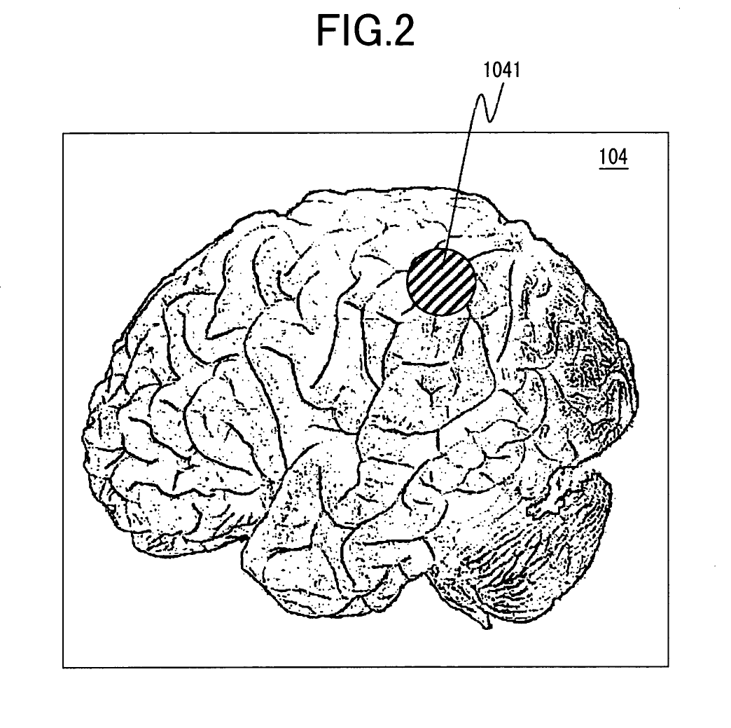

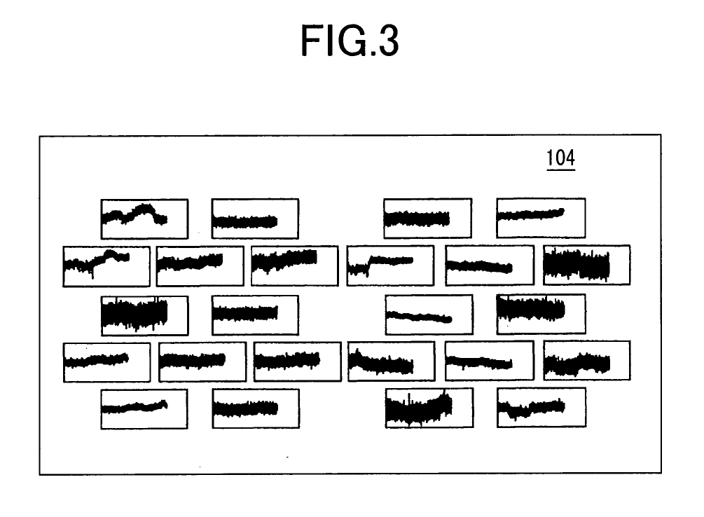

When the signal corresponding to the brain activity of the trainee is collected by the information processor 108 via the brain activity measurement unit 101, the cable 102 for transmitting signals of brain activity, and the signal converter 103, various signal processings prepared in advance are performed and the measurement result presentation 104 is shown on the display unit 120. For example, an activated region 1041 is displayed in color on an entire brain image, as shown in FIG. 2. It is also possible to display variations in time series, such as variations in the intensity of detected light, in each of measurement regions on the measurement result presentation 104 as shown in FIG. 3. Although the training task presentation 110 and the measurement result presentation 104 are shown in separate and parallel regions on the display unit 120, each of them may be shown individually in full-screen display. It is also possible to provide two display units 120 and show the training task presentation 110 and the measurement result presentation 104 on the individual display units 120. Although the process described thus far is based on a brain function measurement method using near infrared light, the brain activity measurement unit used in the present invention is not limited thereto. The brain activity measurement unit involved in the present invention may also be a brain activity measurement system based on fMRI (functional Magnetic Resonance Imaging) or PET, an electroencephalograph, magnetoencephalography, or the like, the use of which has already been prevalent. In this case, a signal converter corresponding to the brain activity measurement unit is adopted.

The training assistant system according to the present invention uses a brain activity measurement system represented by the foregoing structure and procedure.

If the trainee or the trainer has been informed of a region in the brain proper for the evaluation of a training effect and if it is possible to set at least one region of interest (ROI) at which brain activity measurement is performed, the trainee wears the brain activity measurement unit 101 on the portion of the head from which measurement for the ROI can be performed. Or, if the brain activity measurement unit 101 has the light emitting probes and the light detecting probes which allow measurement over the entire head, the trainee or the trainer inputs the address of the probe corresponding to at least one ROI via the input unit 116 and the information processor 108 that has received the inputted address sends the light emission signal to the signal converter 103 such that light is emitted from the probe corresponding to the address. The light intensity signal detected from the probe corresponding to the address is collected by the information processor 108 via the signal converter 103.

The information processor 108 is capable of receiving in real time a measurement signal resulting from the measurement by the brain activity measurement unit 101 via the signal converter 103, while simultaneously transmitting a training task signal to the display unit 120 and thereby displaying the training task on the training task presentation 110. The received measurement result is subjected to signal processing performed by the information processor 108, if necessary, and held in the memory such that it is displayed in real time on the measurement result presentation 104.

### Embodiment 1

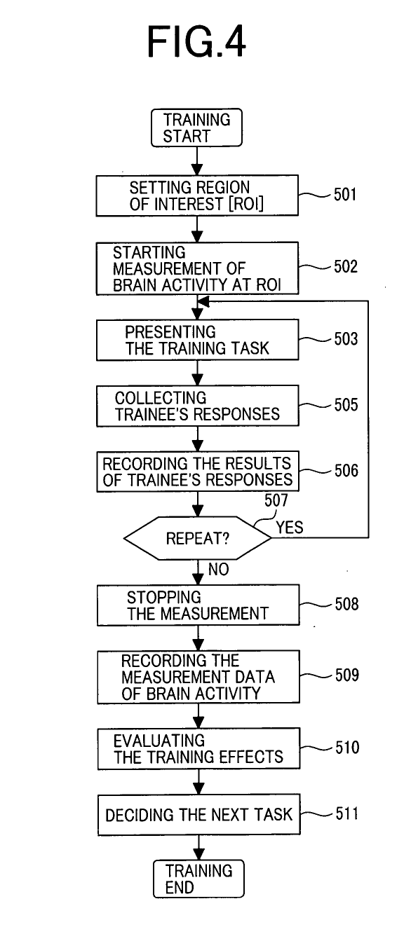

A description will be given to the case described above where the trainee or the trainer can set the ROI by using the training assistant system shown in FIG. 1 by taking an specific example of the training task. The training procedure is shown in FIG. 4.

First, the trainee or the trainer wears the brain activity measurement unit 101 such that measurement is performed at the ROI (Step 501). It is assumed herein that the training task is a calculation task and a description will be given on the assumption that the ROI is the working memory in the frontal cortex. Before the training is initiated, the information processor 108 performs signal transmission and reception with the brain activity measurement unit 101 through the cable 102 for transmitting signals of brain activity via the signal converter 103 and initiates measurement at the ROI (Step 502). The result of measurement is transmitted in real time to the information processor 108 which collects data and shows it on the measurement result presentation 104.

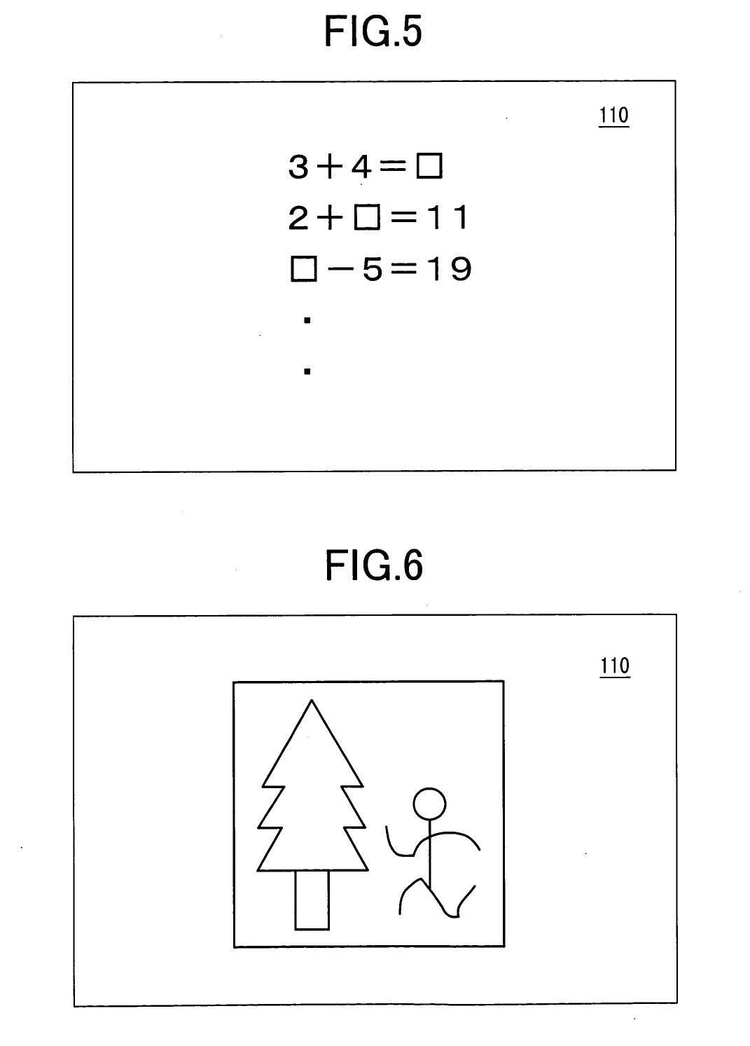

Then, the training is initiated and the training task signal in accordance with a program corresponding to the training task is transmitted from the information processor 108 so that the calculation task is presented on the training task presentation 110 of the display unit 120, as shown in FIG. 5 (Step 503). When the calculation task shown in FIG. 5 is presented, the trainee performs calculation and inputs the result of calculation to the trainee's response collection unit 111 (Step 505). When the training task is the calculation task, the trainee's response collection unit 111 is composed of a device capable of receiving a numerical input such as a keyboard. If the training task is a response to a sound or voice, the microphone 113 is used in place of the trainee's response collection unit 111. The content of the response from the trainee is transmitted in real time to the information processor 108 and stored (Step 506). In Step 506, information effective in evaluating the result of training such as the time at which the training task is presented by the program, the time of response from the trainee, and the result of a comparison with a correct answer is stored as a record of the result of training in the information processor 108 in conjunction with a record of the content of the response from the trainee. Based on the program corresponding to the training task, it is judged whether or not the training should be continued any longer (Step 507) and the judgment is repeated until a session of training is completed. Step 507 may also be performed by a process of displaying a question to the trainee based on the program and obtaining an answer, instead of the process in which the trainer views the measurement result presentation 104, evaluates the result, and makes a judgment. The number of times the judgment is repeated may be preset based on the program corresponding to the training task.

Concurrently with the training executed in Steps 503 to 507, the information processor 108 is receiving in real time the measurement signal from the ROI in the brain for which the measurement is initiated in Step 502. If it is judged that the training should not be continued in Step 507, the measurement at the ROI is continued for a specified period of time from the completion of the training and then the measurement at the ROI is completed (Step 508). The measurement signal from the ROI received in real time is stored together with the time of measurement in the information processor 108 to form a record of measurement result (Step 509).

Subsequently, a training effect is evaluated in Step 510. The present invention evaluates the result of the training based not only on the record of training result (Step 506) indicative of the situation in which the trainee responded (Step 505) corresponding to the training task presentation (Step 503) but also on the record of measurement result obtained from the ROI in the brain for which the measurement is initiated in Step 502 and completed in Step 509. There are various approaches for evaluation performed by the information processor 108, the examples of which are as follows.

(1) The promptness and preciseness of a response from the trainee to the presented training task is evaluated from the record of training result (Step 506) obtained from the trainee.

(2) Brain activity when the trainee responds to the training task is evaluated. For evaluation, a method of obtaining, from the record of measurement result, the brain activity corresponding to the response from the trainee is used. The brain activity corresponding to the response does not necessarily occurs in coincidence with the time of response from the trainee. There are cases where the brain activity corresponding to the response occurs slightly earlier or later than the time of response so that the peak value of brain activity at the ROI is determined about, e.g., 5 second before or after the time of response.

(3) The promptness and preciseness in the approach (1) are evaluated for each continued session of training and variations in promptness and preciseness throughout the training session from the initiation to completion thereof are evaluated.

(4) The peak value of brain activity calculated in the approach (2) is determined for each continued session of training and variations in peak value throughout the training session from the initiation to completion thereof are evaluated.

Since it is assumed herein that the ROI is the working memory in the frontal cortex, if the brain activity is lower at the completion of the training than at the initiation thereof as a result of the evaluation in the approach (4), it can be judged that the training effect is recognized. This indicates that the trainee has been skilled enough to perform the training task without so much depending on the temporary storage. As a result of evaluation in the approach (3), an improvement in training effect can be recognized from the result of brain activity measurement even if a training effect recognizable from the outside, such as an improvement in promptness and preciseness, is not observed at this time. If a training effect is recognized in the result of evaluation in the approach (3), on the other hand, an improvement in training effect can be recognized even if a training effect cannot be judged from the result of evaluation in the approach (4). If a training effect recognizable from the outside is not observed in the result of evaluation in-the approach (3) and if the peak value of brain activity is invariable or tends to increase in the result of evaluation in the approach (4), it is judged that a training effect has not been achieved yet.

As criteria for evaluation in the approach (3), it is assumed that a response time of 3 seconds and a correct answer rate of 80% are exemplary threshold values for judging that a training effect is present and a response time of 5 seconds and a correct answer rate of 70% are exemplary threshold values for judging that a training effect is absent. It is also assumed that a 5% change in the peak value of brain activity has been set as a threshold value for evaluation in the approach (4). If the peak value of brain activity at the completion of training is 5.5% lower than the peak value of brain activity at the initiation of training irrespective of a response time of 4.5 seconds and a correct answer rate of 75% obtained from the trainee, the information processor 108 shows the response time, the correct answer rate, and time-series variations in the peak value of brain activity on the display unit 120, while also showing the result of judgment that a training effect is present on the display unit 120, and uses these results of evaluation and judgment in the step of determining a training task for the next session.

By thus using the training assistant system according to the present invention, a visible training effect and a change in the brain which cannot be recognized from the outside work complementarily to allow the evaluation of a training effect.

There may be a contradictory case where, judging from the result of evaluating changes in the approach (4), the peak value of brain activity is invariable or tends to increase and a training effect has not been achieved yet, though it can be judged from the result of evaluating changes in the approach (3) that a training effect is recognized. In that case, it can be evaluated that a visible effect has not been achieved in terms of brain activity. That is, it cannot be said that the ROI in the brain was stimulated sufficiently by the training task performed at that time. Therefore, it is necessary in that case to perform training by changing the training task and evaluate the result.

Although the evaluation described above is performed based on the results of training and measurement of brain activity of the current training session, it is also possible to compare the results of training and measurement in the current session of training with the results of training and measurement in the previous sessions of training since the results of training of this type can be accumulated for the trainee. By thus statistically evaluating the results of training and measurement, it becomes possible to comprehensively evaluate an effect recognizable from the outer appearance and an effect unrecognizable from the outer appearance.

The information processor 108 can assist the trainer with the evaluation of the result of training the trainee by mounting thereon several programs for such evaluation methods and displaying the results of evaluation. It is also possible to effect automatic evaluation in accordance with an evaluation method selected preliminarily by the trainer for each trainee.

Based on the results of evaluation described above, a next training task is determined (Step 511). If the result of evaluation is that a training effect is recognized, a task on a higher difficulty level is determined by shortening a standard time required by the trainee to respond or giving a more complicated calculation task. If it is judged that a training effect is not recognized, a task on the same difficulty level or an easier task is determined or the training task is changed.

A description will be given to the case where the threshold values in Step 510 are the same as described above. When a response time of 12 seconds and a correct answer rate of 75% were obtained from the trainee and the peak value of brain activity was 3.0% lower as a result of evaluation in the approaches (3) and (4), the information processor 108 shows the results of evaluation on the display unit 120 and also the judgment that a training effect is absent on the display unit 120. At the same time, the information processor 108 performs the process of judging that the difficulty level is low if the correct answer rate is 90% or more and raising the difficulty level of a next training task or the process of judging that the difficulty level is high if the correct answer rate is less than 50% and lowering the difficulty level of the next training task. The response time can also be used for the judgment of the difficulty level. If the response time is 10 seconds or longer, the difficulty level is judged to be high. If the response time is less than 1 second, the difficulty level is judged to be low. In this case, the response time is over 10 seconds so that the difficulty level is judged to be high and the difficulty level of the next training task is set low. More specifically, a three-digit multiplication task is changed to a 2-digit multiplication task and the content of the next training task is shown together with the results of evaluation and judgment of a training effect on the display unit 120. When a next session of training is performed, it is possible for the information processor 108 to receive the name and ID of the trainee inputted thereto, read the training task for the trainee, and thereby initiate the training.

A description will be given next to a training procedure if the training task is assumed to be a memorization task. The flow of FIG. 4 need not be changed even if the training task is changed from the calculation task to the memorization task. Although it is necessary to set the ROI depending on the training task when the training task is changed, the working memory in the frontal cortex is set assumedly as the ROI in the same manner as in the calculation task.

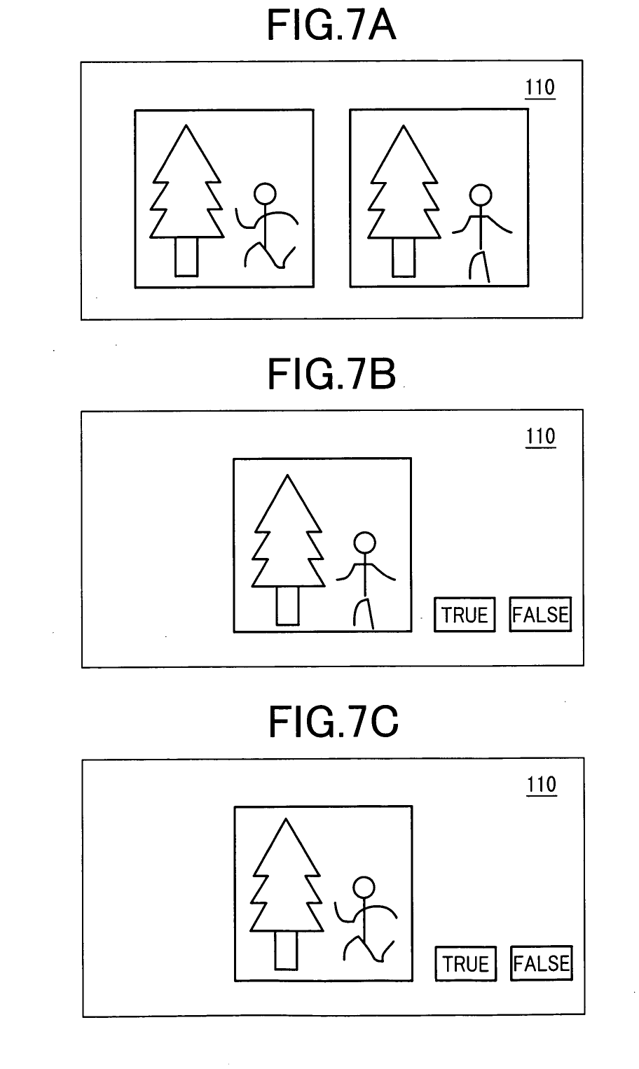

In Step 503, an image such as a photograph or a picture is presented as a memorization task, as shown in FIG. 6. The training task presentation 110 presents the image to be memorized for a short period of time and dismisses it. Then, images for recognition for the checking of whether or not the image has been memorized are presented. FIGS. 7A to 7C are views showing examples of images for recognition, of which FIG. 7A shows an example in which a true image and a false image are presented in juxtaposition, FIG. 7B shows an example in which only the false image is presented, and FIG. 7C shows an example in which only the true image is presented. In response to the presentation of the images for recognition, the trainee judges which one of the presented images in FIG. 7A is true and inputs the result of judgment as a response to the trainee's response collection unit 111 or inputs a response by touching the true image of the training task presentation 110. In FIG. 7B and 7C, the trainee inputs True or False as a response to the trainee's response collection unit 111 or inputs a response by touching the True or False characters displayed aside the image for recognition.

Even if the training task is changed from the calculation task to the memorization task, the flow of FIG. 4 need not be changed. In the evaluation of a training effect in Step 510 of FIG. 4 also, evaluations can be performed in accordance with the same procedure as in the calculation task. Specifically, the foregoing approaches (1) to (4) which evaluate the promptness and preciseness of a response from the trainee and the brain activity can be used for evaluation.

### Embodiment 2

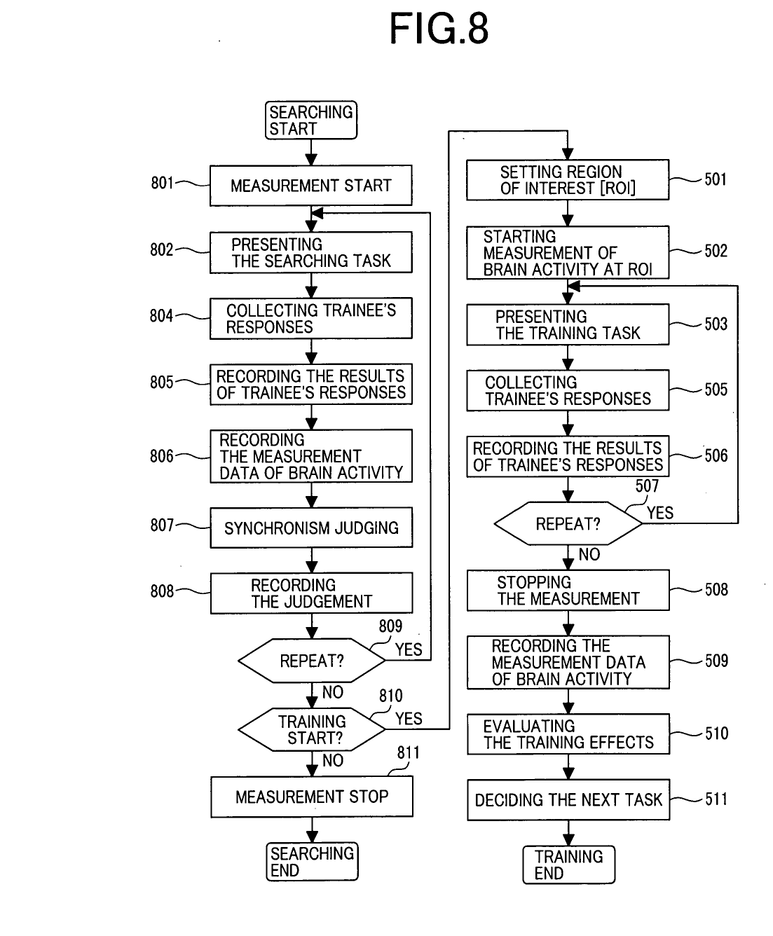

A description will be given next to the case where the trainee is a patient with a damage in the brain and the ROI cannot be specified in advance. In this case, a search for specifying ROI is performed first and then the measurement of brain activity at the ROI and training are performed. In this case also, the entire structure of the system may be the same as shown in FIG. 1. FIG. 8 shows the flow of measurement for a search and subsequent training. It will easily be understood that, in the measurement performed in this case also, not only the measurement signal or the response signal from the trainee but also the timing of collecting the signal are the same as in the foregoing embodiment.

First, the trainee wears the brain activity measurement unit 101 on his or her head such that measurement is performed over the entire brain. It is assumed herein that the trainee has an impairment in the brain and has left hand fingers paralyzed and that a search task for searching ROI is a physical movement task. If the trainee has an impairment in the brain and the impaired region exhibits no activity, a compensatory region in the brain which is activated in response to the task should be searched.

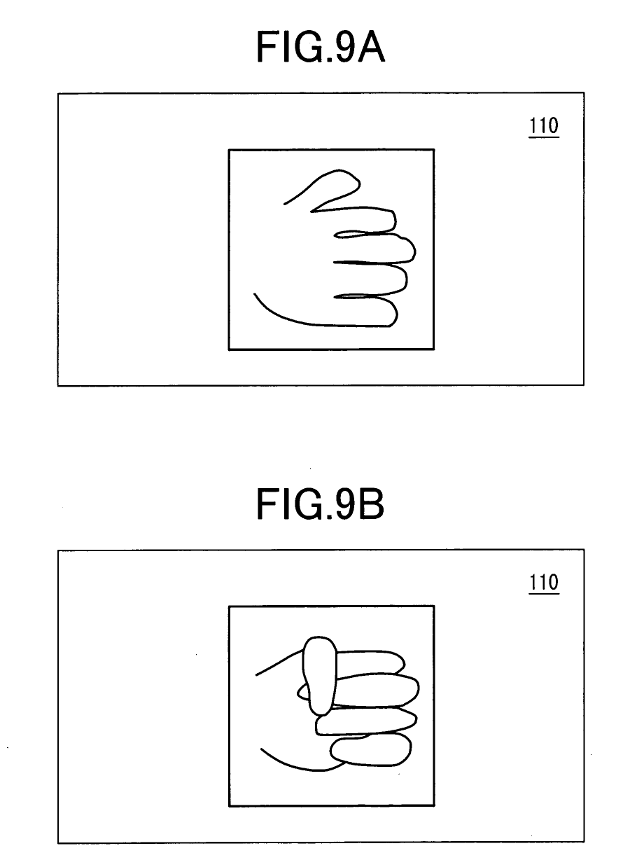

Prior to the initiation of the search, the measurement of brain activity is initiated (Step 801) in the same manner as in Step 502 in the case of training described with reference to FIG. 4. The information processor 108 performs signal transmission and reception with the brain activity measurement unit 101 via the signal converter 103 and the cable 102 for transmitting signals of brain activity and initiates measurement over the entire brain, while receiving the result of measurement in real time. In this state, the training task presentation 110 presents the search task to the trainee (Step 802). If the trainee cannot move the left hand at all regardless of his or her intensive effort, not only an instruction in a sentence but also, e.g., an image of a left hand is presented on the training task presentation 110 so that the trainee easily performs image training. FIGS. 9A and 9B show examples of the left hand image presented on the training task presentation 110, of which FIG. 9A shows an image of an open palm and FIG. 9B shows an image of a closed hand. By alternately presenting the two images, the trainee is urged to perform physical movements following the presented images. It is also possible to show the two images as a continuous animation sequence with no interruption therebetween. An instruction in a sound or voice may also be added. When the search task is presented, the trainee mimics the physical movements as closely as possible in an attempt to follow the display and, if the trainee cannot perform the physical movements; he or she imagines the physical movements. The physical movement of the trainee is inputted to the response collection unit 111 (Step 804) and the response from the trainee is collected as data by the information processor 108 (Step 805).

Meanwhile, data obtained from measurement over the entire brain initiated in Step 801 is collected in real time by the information processor 108, as described above. However, the measurement data from the entire brain is shown as a record of measurement result in Step 806 for the convenience of description. The record of response result obtained in Step 805 and the record of measurement result obtained in Step 806 are used to compare the timing of the physical movement of the trainee in response to the search task or the timing of the image with the timing of the measurement data from the entire brain and thereby evaluate synchronism. The information processor 108 evaluates, for each of the measurement regions in the brain, whether or not the physical movement of the trainee in response to the search task is in synchronism. As a method for evaluating synchronism, the region in synchronism is determined by using a correlation coefficient or a calculation method represented by that disclosed in Non-Patent Document 3. The result of judging synchronism is stored as a record of synchronism judgment result in the information processor 108 (Step 808). For the evaluation of synchronism, a number of search tasks may be presented appropriately in a short period of time. For easy synchronism with the active region in the brain, the information processor 108 receives the result of measurement in real time from the signal converter 103, while simultaneously recording, in each result of measurement, the time at which a signal presenting the search task of the hand closing movement and the hand opening movement is transmitted onto the training task presentation 110. If the active region in the brain in synchronism is identified in Step 808, it is judged that the search should not be continued (Step 809) and if the search immediately proceeds to the initiation of training, the training is initiated by regarding the region as the ROI (Step 810). It is also possible to complete the search or training depending on the degree of fatigue of the trainee (Step 809, Step 810). In this case, the measurement is completed at this stage (Step 811). As is obvious from a comparison with FIG. 4, training after the ROI is specified by the search procedure is performed in accordance with the same procedure.

In the foregoing embodiment, the trainee or the trainer is also allowed to judge synchronism without depending on automatic judgment by the information processor 108. It is also possible for the trainee or the trainer who has observed the result of measurement displayed as shown in FIG. 2 or 3 to determine the active region in the brain in synchronism, set the ROI by using the input unit 116, and initiate training.

### Embodiment 3

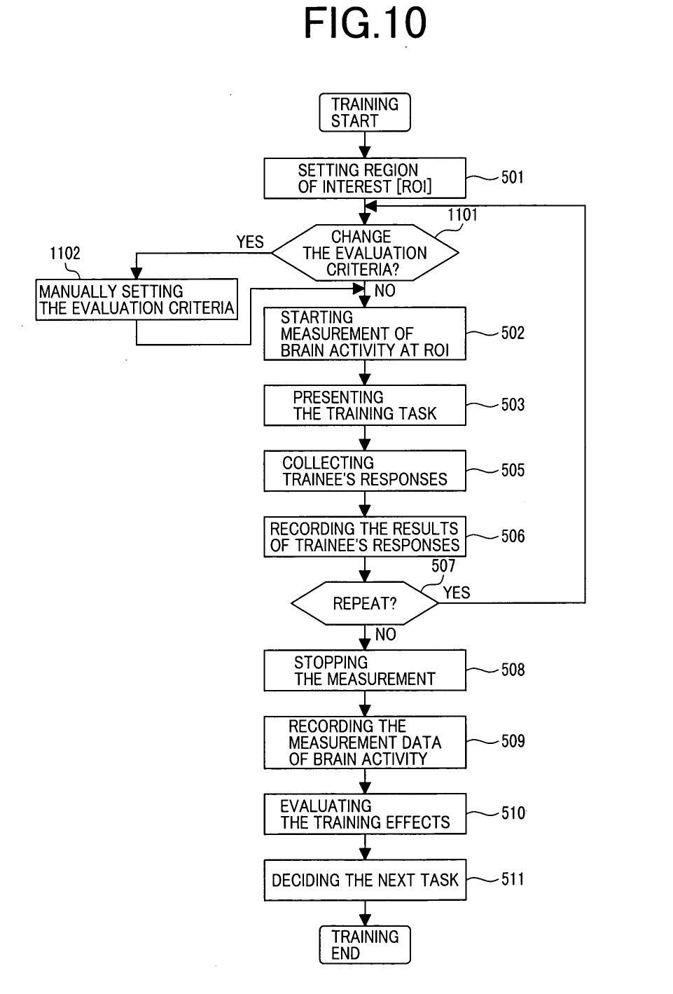

For the setting of evaluation criteria when the information processor 108 performs calculation or judgment, the training assistant system shown in FIG. 1 also allows the trainee or the trainer to input the criteria by using the external input means 116. When the trainee performs image training, there is a possibility that, at the initial stage of training, it takes a long time until a training effect is recognized in the result of brain activity measurement. If a training effect is invisible, the trainee may become less passionate and motivated about the training. In this case, the evaluation criteria in the information processor 108 is set rather lower such that a training effect is judged from even a slight change in the result of brain activity measurement. FIG. 10 shows a training procedure having such additional steps of setting evaluation criteria. As can be seen from a comparison between FIGS. 10 and 4, the training procedure shown in FIG. 10 is the same as the training procedure shown in FIG. 4 except that Step 1101 of questioning whether or not evaluation criteria should be changed and Step 1102 of manually setting evaluation criteria are added thereto.

In the case of adopting the training procedure shown in FIG. 10, if the result of training judged from the outer appearance is conceivably unsatisfactory after the continuation of training is selected several times in Step 507, Yes is selected in response to the question of whether or not evaluation criteria should be changed in Step 1101 and the whole process proceeds to Step 1102 of manually setting evaluation criteria where the current evaluation criteria are changed to evaluation criteria considering the result of training. Specifically, it is checked when the repetition of training is started evaluation criteria should be changed and, if the changing of evaluation criteria is necessary, training is performed by lowering the evaluation criteria. It will easily be appreciated that, if the trainee shows an excellent training effect, training may be performed by raising the evaluation criteria. It is also possible to change the evaluation criteria at the beginning of this session of training based on the result of the previous session of training.

### Embodiment 4

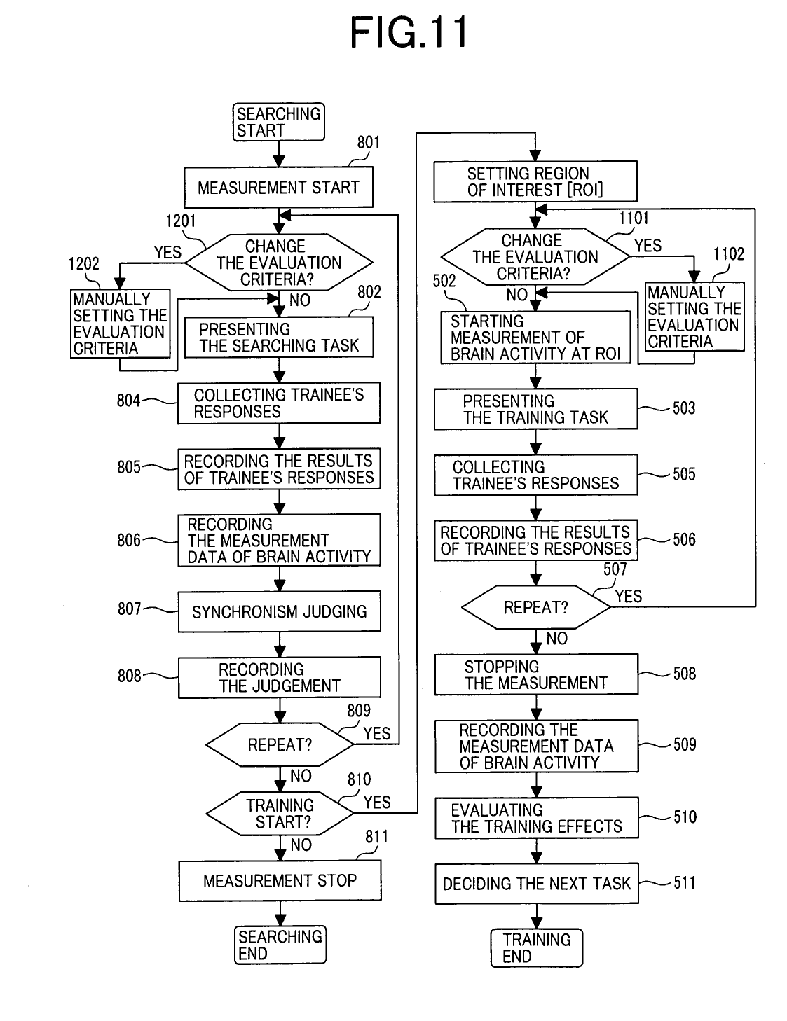

If a compensatory region which functions in place of the damaged region in the brain is searched as in the case where the trainee is a patient having a damage in the brain, it is also possible to set evaluation criteria for the search task. FIG. 11 shows the flow of measurement for a search process having such additional steps of setting evaluation criteria and subsequent training. As can be seen from a comparison between FIGS. 11 and 8, the flow shown in FIG. 11 is the same as the flow of measurement for a search and subsequent training shown in FIG. 8 except that Step 1201 of questioning whether or not evaluation criteria should be changed and Step 1102 of manually setting evaluation criteria are added thereto.

In the case of adopting the procedure for measurement for a search and subsequent training shown in FIG. 11, if the result of the search judged from the outer appearance is conceivably unsatisfactory after the continuation of the search is selected several times in Step 809, Yes is selected in response to the question of whether or not evaluation criteria should be changed in Step 1201 and the whole process proceeds to Step 1202 of manually setting evaluation criteria where the current evaluation criteria are changed to evaluation criteria considering the result of the search. The changing of evaluation criteria in the training procedure is the same as described above. Specifically, it is checked when the repetition of the search is started whether or not evaluation criteria should be changed and, if the changing of evaluation criteria is necessary, the search is performed by lowering the evaluation criteria. It will easily be appreciated that, if the degree of the impairment of the trainee is extremely high, the search may be performed by lowering the evaluation criteria from the beginning.

In each of the foregoing procedures, the training assistant system shown in FIG. 1 may also allows the information processor 108 to automatically determine a next training task to be performed or allows the trainee or the trainer to determine the next training task to be performed. The trainee or the trainer is allowed to input the next training task to be performed to the information processor 108 by using the input unit 116 through the visual judgment of a training effect achieved by the trainee or through the judgment of the training effect from the result of measurement displayed on the measurement result presentation 104.

### Example 5

The training assistant system according to the present invention is also applicable to an infant having paralyzed hands and feet. Recently, rehabilitation for infants shortly after birth who have paralyzed hands and legs has been performed. However, since an infant cannot utter significant words, a problem is encountered that it is impossible to judge whether the paralyzed feet and hands are congenital or acquired. If early-stage measures are taken to the infant, it is expected that the congenitally lost function is restored or the prospective occurrence of an acquired functional disorder is suppressed since the brain function and motor function of the infant are at growth stage and excellently developing.

Since an infant cannot utter significant words and cannot sufficiently understand words, there is no alternative but to perform the presentation of a training task primarily by using display and a sound or voice and the detection of a response based on a touch on the screen and a physical movement in response to the sound or voice.

### Example 6

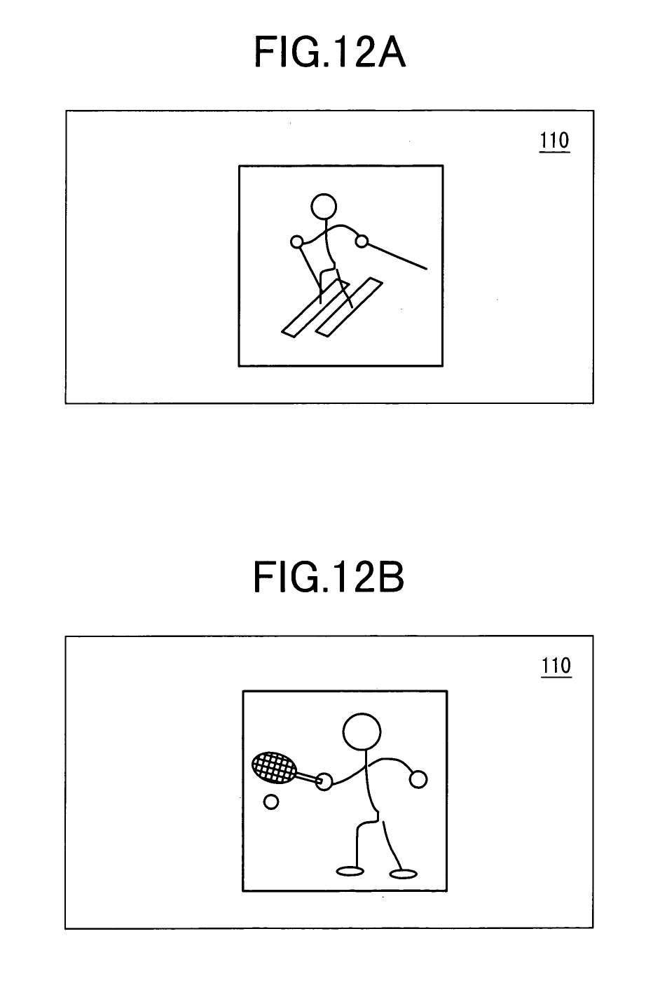

The present invention is usable not only for the training of an impaired person but also for image training for a sport. In this case, the training task presentation 110 presents images of a sport and training associated therewith, as shown in FIGS. 12A and 12B. The trainee imagines himself or herself participating in the sport, while viewing the images, and simultaneously measures brain activity such that he or she evaluates a training effect in accordance with the foregoing various procedures and improves the training menu.

Since the evaluation of training based on both of the result of a training effect which can be evaluated from the outer appearance and brain activity corresponding thereto can be performed, training can be optimized.

What is claimed is:

1. A training assistant system comprising:
a training task presentation unit for presenting a training task and a training content to a trainee;
a trainee's response collection unit capable of collecting, from the trainee, a response in accordance with the training task and the training content;
a brain activity measurement unit for measuring brain activity of the trainee; and
an information processor for controlling the presentation by said training task presentation unit and determining a next training task to be performed such that at least a result of the response obtained from said trainee's response collection unit and a result of measuring the brain activity of the trainee in a training execution process, which is obtained from said brain activity measurement unit, are reflected in the next training task to be performed.

2. A training assistant system according to claim 1, wherein said brain activity measurement unit is capable of measuring the brain activity at each of a plurality of regions in a brain and has a unit for selecting, from among said plurality of regions, a region of interest used to evaluate a result of training and determine the next training task to be performed.

3. A training assistant system according to claim 1, wherein said information processor controls said training task presentation unit such that a task for searching a region of interest, which is for selecting a proper region of interest in a training process, is presented prior to the presentation of said training task.

4. A training assistant system according to claim 1, wherein said information processor is capable of setting evaluation criteria for the result of training the trainee and evaluates said result of training the trainee based on the set evaluation criteria.
